(19) United States
(12) Patent Application Publication
(10) Pub. No.: US 2021/0027201 A1
(43) Pub. Date: Jan. 28, 2021

(54) CLASSIFIER CORRECTION DEVICE, CLASSIFIER CORRECTION METHOD, AND STORAGE MEDIUM

(71) Applicant: NEC Corporation, Minato-ku, Tokyo (JP)

(72) Inventor: Atsushi SATO, Tokyo (JP)

(73) Assignee: NEC Corporation, Minato-ku, Tokyo (JP)

(21) Appl. No.: 16/979,658

(22) PCT Filed: Mar. 13, 2019
(86) PCT No.: PCT/JP2019/010171

§ 371 Date: Sep. 10, 2020

(30) Foreign Application Priority Data
Mar. 19, 2018 (JP) 2018-051209

(51) Int. Cl. G06N 20/00; G06F 16/906

(52) U.S. Cl. CPC G06N 20/00; G06F 16/906

(57) ABSTRACT

Accuracy of a classifier is improved when there is an imbalance between classes. A classifier correction device is for a classifier that classifies a target vector into one of a plurality of classes based on a plurality of reference vectors each belonging to any one of the plurality of classes. The classifier correction device includes a set selection unit and a correction unit. The set selection unit selects a set of learning vectors belonging to different classes from among a plurality of learning vectors each belonging to any one of the plurality of classes, each of the plurality of classes having at least one of the plurality of learning vectors. The correction unit performs correction processing for each of the learning vectors included in the set in such a way as to correct, by using the learning vector as a basis, the reference vector specified based on the learning vector.

### TECHNICAL FIELD

The present disclosure relates to learning by classifiers to be used by computers to recognize patterns such as voices and images.

### BACKGROUND ART

Pattern recognition generally refers to a technique for classifying input data, such as an image and a voice, or an object represented by the data into one of classes, based on a pattern (also called an input pattern) extracted from the data. In general, an input pattern is expressed in the form of a vector. Thus, an input pattern is also referred to as an input vector or feature vector in the present disclosure.

Recently, a nearest neighbor classifier (NNC) is known as one of typical classifiers to be used for pattern recognition. The NNC is a classifier that uses a reference vector (also called a recognition dictionary, template, or prototype) prepared for each class. Specifically, the NNC outputs, as a result of classification of an input vector, a class to which a reference vector located at a shortest distance from the input vector (that is, a nearest neighbor reference vector) belongs.

There is known a technique for correcting a reference vector by using an input vector for learning so as to reduce errors in classification in a pattern recognition device such as the NNC described above that performs classification by using a reference vector. Correction of reference vectors is also referred to as learning of reference vectors. In the present disclosure, correction of reference vectors is equivalent to correction for a classifier.

PTL 1 is patent literature that discloses a recognition dictionary generating device that learns reference vectors. The recognition dictionary generating device acquires a learning input vector to which a correct class is assigned. Then, the recognition dictionary generating device corrects a reference vector in the vicinity of the learning input vector (in other words, a reference vector similar to the learning input vector) by using the learning input vector as a basis. The recognition dictionary generating device generates a recognition dictionary with improved accuracy by correcting a reference vector for each of the acquired learning input vectors.

Techniques disclosed in PTLS 2 and 3 are not techniques for correcting reference vectors, but techniques relating to pattern learning.

PTL 2 discloses a technique for devising a way to provide annotations so as to eliminate a risk that classification accuracy for a low-frequency class may decrease in the case of handling data (hereinafter also referred to as “unbalanced data”) with a variation (imbalance) in class frequency (that is, the number of pieces of data belonging to each class).

PTL 3 discloses a technique for efficiently performing learning by using only a node having an edge between different classes, which is an edge connecting nodes across classes, for learning.

### CITATION LIST

### Patent Literature

[PTL 1] PCT International Publication No. WO 2012/095938 A
[PTL 2] Japanese Unexamined Patent Application Publication No. 2017-107386 A
[PTL 3] Japanese Unexamined Patent Application Publication No. 2016-048416 A

### SUMMARY OF INVENTION

### Technical Problem

When there is an imbalance in the number of pieces of data between classes, there is a possibility that classification accuracy for a class with a small number of pieces of data (hereinafter, simply referred to as “number of pieces of data”) is not sufficiently improved if a method for correcting reference vectors as disclosed in PTL 1 is simply applied. This is because the number of learning input vectors is small in a class with a small number of pieces of data, and accordingly, the number of times a reference vector is corrected in the vicinity of a learning input vector is less than the number of times a reference vector is corrected in the vicinity of a learning input vector of a class with a large number of pieces of data.

It is one of objects of the present invention to provide a device, a method, a program, and the like capable of efficiently improving accuracy even for, in particular, a classifier that performs classification in the case where there is an imbalance in the number of pieces of data between classes.

### Solution to Problem

A classifier correction device according to one aspect of the present invention is a classifier correction device for a classifier that classifies a target vector into one of a plurality of classes based on a plurality of reference vectors each belonging to any one of the plurality of classes, the classifier correction device including: a set selection means for selecting a set of learning vectors belonging to different classes from among a plurality of learning vectors each belonging to any one of the plurality of classes, each of the plurality of classes having at least one of the plurality of learning vectors; and a correction means for performing correction processing for each of the learning vectors included in the set in such a way as to correct, by using the learning vector as a basis, the reference vector specified based on the learning vector.

A classifier correction method according to one aspect of the present invention is a classifier correction method for a classifier that classifies a target vector into one of a plurality of classes based on a plurality of reference vectors each belonging to any one of the plurality of classes, the method including: selecting a set of learning vectors belonging to different classes from among a plurality of learning vectors each belonging to any one of the plurality of classes, each of the plurality of classes having at least one of the plurality of learning vectors; and performing correction processing for each of the learning vectors included in the set in such a way as to correct, by using the learning vector as a basis, the reference vector specified based on the learning vector.

A program according to one aspect of the present invention is a program for a classifier that classifies a target vector into one of a plurality of classes based on a plurality of reference vectors each belonging to any one of the plurality of classes, the program causing a computer to perform: set selection processing of selecting a set of learning vectors belonging to different classes from among a plurality of learning vectors each belonging to any one of the plurality of classes, each of the plurality of classes having at least one of the plurality of learning vectors; and correction processing for each of the learning vectors included in the set in such a way as to correct, by using the learning vector as a basis, the reference vector specified based on the learning vector. The program described above may be stored on a non-transitory computer-readable storage medium.

### Advantageous Effects of Invention

According to the present invention, accuracy can be efficiently improved even for, in particular, a classifier that performs classification in the case where there is an imbalance in the number of pieces of data between classes.

### BRIEF DESCRIPTION OF DRAWINGS

FIG. 1 is a diagram illustrating the concept of a method for correcting reference vectors.

FIG. 2 is another diagram illustrating the concept of the method for correcting reference vectors.

FIG. 3 is a block diagram illustrating a configuration of a classifier correction device according to a first example embodiment of the present invention.

FIG. 4 is a flowchart illustrating the flow of processing by the classifier correction device according to the first example embodiment.

FIG. 5 is a diagram conceptually illustrating an example in which reference vectors are corrected by the classifier correction device according to the first example embodiment.

FIG. 6 is a diagram conceptually illustrating the reference vectors and a classification boundary after correction.

FIG. 7 is a block diagram illustrating a configuration of a classifier correction device according to a second example embodiment of the present invention.

FIG. 8 is a flowchart illustrating the flow of processing by the classifier correction device according to the second example embodiment.

FIG. 9 is a first diagram for describing a definition of the proximity of vectors to the region of a class.

FIG. 10 is a second diagram for describing a definition of the proximity of the vectors to the region of the class.

FIG. 11 is a third diagram for describing a definition of the proximity of the vectors to the region of the class.

FIG. 12 is a block diagram illustrating a configuration of a modified example of the classifier correction device according to the second example embodiment.

FIG. 13 is a block diagram illustrating a configuration of a classifier correction device according to an example embodiment of the present invention.

FIG. 14 is a flowchart illustrating the flow of a classifier correction method according to the example embodiment of the present invention.

FIG. 15 is a block diagram illustrating an example of hardware included in each unit of each example embodiment of the present invention.

### EXAMPLE EMBODIMENT

For ease of understanding, the following description is based on the assumption that there are two classes of a “positive class” and a “negative class”. However, the present invention is also applicable to classifiers that classify data into three or more classes. Those skilled in the art may interpret the following description or read the following description by modifying the wording thereof with a view to applying techniques set forth in the following description to classifiers that classify data into three or more classes, as appropriate, and the techniques interpreted that way may also be included in the technical scope of the present invention. In the drawings, a vector is represented as a point in a two-dimensional plane, but the number of components of a vector does not matter.

In the following description, an input vector is represented by characters starting with x, and a reference vector is represented by characters starting with y. The superscript “+” is assigned to a vector labeled “positive class”. The superscript “−” is assigned to a vector labeled “negative class”.

Before describing example embodiments of the present invention, a known method for correcting reference vectors (hereinafter referred to as “known technique”) as described in PTL 1 will be specifically described.

In the known technique, a computer acquires at least one input vector.

Then, the computer selects a reference vector closest to the acquired input vector for each class. Specifically, the computer determines a reference vector closest to the input vector, among reference vectors of the positive class, and a reference vector closest to the input vector xᵢ⁺, among reference vectors of the negative class. The term “closest” means that a value calculated by use of a method for calculating the distance between vectors (for example, the Euclidean distance between two points representing a vector in Euclidean space) is the smallest.

The computer then corrects each of the determined reference vectors.

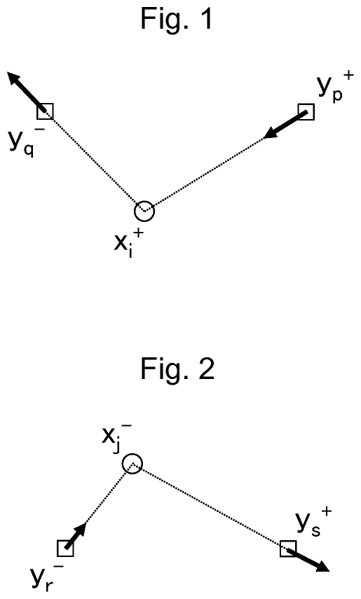

FIGS. 1 and 2 are diagrams illustrating the concept of correcting reference vectors in the known technique.

For example, when the input vector xᵢ⁺ of the positive class is acquired, the computer corrects a reference vector yₚ⁺ closest to the input vector xᵢ⁺, among the reference vectors of the positive class in such a way as to bring the reference vector yₚ⁺ closer to the input vector xᵢ⁺, as illustrated in FIG. 1. In addition, the computer corrects a reference vector y_{q}⁻ closest to the input vector xᵢ⁺, among the reference vectors of the negative class in such a way as to move the reference vector y_{q}⁻ away from the input vector xᵢ⁺.

For example, when an input vector xⱼ⁻ of the negative class is acquired, the computer corrects a reference vector yₛ⁺ closest to the input vector xⱼ⁻, among the reference vectors of the positive class in such a way as to move the reference vector yₛ⁺ away from the input vector xⱼ⁻, as illustrated in FIG. 2. In addition, the computer corrects a reference vector yᵣ⁻ closest to the input vector xⱼ⁻, among the reference vectors of the negative class in such a way as to bring the reference vector yᵣ⁻ closer to the input vector xⱼ⁻.

An example of a specific method for correcting vectors in the known technique is as follows. Assuming that xₐ is an input vector, y_{c} is a reference vector to be brought closer, and y_{d} is a reference vector to be moved away, the computer corrects the vector y_{c} and the vector y_{d} according to the following expressions.

y_{c}←y_{c}+ε∥xₐ−y_{d}∥^{m}(xₐ−y_{c})

y_{d}←y_{d}+ε∥xₐ−y_{c}∥^{m}(xₐ−y_{d}) [Math. 1]

In each of the above expressions, the arrow represents an operation to replace a value of a variable pointed by the arrow with a value obtained by an expression following the arrow. The symbols ε and m denote set values. The symbol ε denotes a positive real number, and m denotes a real number greater than 1.

According to the known technique described above, a reference vector close to the region of a class with a larger number of input vectors is more likely to be corrected, and a reference vector close to the region of a class with a smaller number of input vectors is less likely to be corrected. In addition, a reference vector to be corrected is not necessarily a reference vector requiring correction.

Example embodiments of the present invention will be described in detail below.

### First Example Embodiment

First, a first example embodiment of the present invention will be described. A classifier correction device 11 according to the first example embodiment is a device that corrects a reference vector to be used by a classifier 21.

<Configuration>

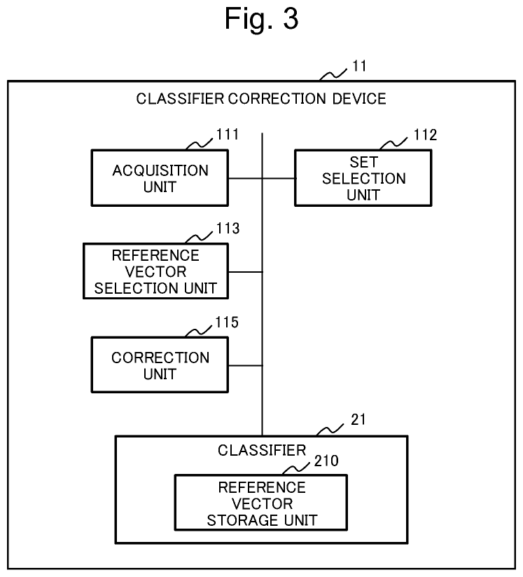

FIG. 3 is a block diagram illustrating an example of the configuration of the classifier correction device 11. The classifier correction device 11 includes an acquisition unit 111, a set selection unit 112, a reference vector selection unit 113, and a correction unit 115.

In the example illustrated in FIG. 3, the classifier correction device 11 also includes the classifier 21. As another aspect, however, the classifier 21 may be external to the classifier correction device 11 and communicably connected to the classifier correction device 11.

The classifier 21 is a module that performs classification. The classifier 21 performs classification by using reference vectors stored in a reference vector storage unit 210. The reference vector storage unit 210 can be implemented by, for example, a random access memory (RAM), a read only memory (ROM), a hard disk, or a portable storage device.

Each of the reference vectors belongs to any one of a plurality of classes. That is, information representing any one of the plurality of classes is assigned to each of the reference vectors in the reference vector storage unit 210.

The respective functions of the constituent elements in the classifier correction device 11 will be described below. As will be described below, each constituent element in the classifier correction device 11 can be implemented by, for example, a computer including a memory and one or more processors that execute instructions based on programs.

When generating or acquiring data, each constituent element in the classifier correction device 11 can make the data available to other constituent elements. For example, each constituent element can transmit the generated or acquired data to other constituent elements that use the data. Alternatively, each constituent element may store the generated or acquired data in a storage area (a memory or the like (not illustrated)) in the classifier correction device 11. When performing processing, each constituent element of the classifier correction device 11 may receive data to be used directly from the constituent element that generates or acquires the data, or may read the data from the storage area described above.

The lines connecting the constituent elements illustrated in FIG. 3 are lines indicating that the constituent elements can exchange data with each other. It is not necessarily required that the constituent elements be connected by signal lines similar to the lines illustrated in FIG. 3.

===Acquisition Unit 111===

The acquisition unit 111 acquires an input vector for learning. Hereinafter, the input vector for learning is simply referred to as “learning vector”. The learning vector is a vector representing data. Examples of the above-described data include image data and audio data. For example, the acquisition unit 111 may acquire a learning vector by deriving the learning vector from data (hereinafter, referred to as “input data”) input to the classifier correction device 11. A generally known method for extracting features from data can serve as a method for deriving a learning vector from input data. As an example, the acquisition unit 111 may divide gray-scale image data as input data into 100 regions, and calculate the average value of luminance values in each region to derive, as a learning vector, a 100-dimensional vector with components of the average values.

The acquisition unit 111 may directly acquire a learning vector from the outside by receiving the input of the learning vector.

The acquisition unit 111 acquires not only a learning vector but also a correct label assigned to the learning vector. The correct label is information representing one of the plurality of classes. For example, the acquisition unit 111 just receives the input of the correct label together with the input of the learning vector or input data when the acquisition unit 111 receives the input of the learning vector or input data. Alternatively, the acquisition unit 111 just acquires, from the outside, information (for example, a data set) in which the correct label is associated with the learning vector or input data.

The acquisition unit 111 acquires at least two learning vectors to which different correct labels are assigned.

===Set Selection Unit 112===

The set selection unit 112 selects a set of learning vectors belonging to different classes from among the learning vectors acquired by the acquisition unit 111.

If there are two types of classes “positive class” and “negative class”, the set selection unit 112 selects, as a set, a pair of one of learning vectors labeled “positive class” and one of learning vectors labeled “negative class”.

When there are N types of classes (N is an integer equal to or greater than 3), the set selection unit 112 selects, for example, one learning vector from each class to select the selected N learning vectors as a set.

Alternatively, the set selection unit 112 may randomly select a given number (a number less than N) of classes from among the N types of classes, and then select one learning vector from each of the selected classes to select the given number of selected learning vectors as a set. If classes are selected at random, the number of times each class is selected is leveled as a result of repeatedly performing the processing of steps S12 to S14 to be described below.

One learning vector may be selected from a plurality of learning vectors belonging to the same class by use of, for example, a method of random selection. The set selection unit 112 may select a set by using a method other than the method of random selection.

===Reference Vector Selection Unit 113===

The reference vector selection unit 113 selects a reference vector to be corrected. Specifically, the reference vector selection unit 113 selects, as reference vectors to be corrected, at least two reference vectors belonging to different classes for each learning vector included in the set selected by the set selection unit 112.

Specifically, the reference vector selection unit 113 may select a reference vector to be corrected based on a distance between the learning vector and the reference vector. The term “distance” refers to a distance in a space in which a vector is represented by a point, such as the Euclidean distance. In the present disclosure, the smallness of a distance between two vectors is regarded as the “proximity” or “similarity” of the two vectors in some cases.

An example of a method for selecting a reference vector will be described. For example, the reference vector selection unit 113 refers to a plurality of reference vectors acquired by the acquisition unit 111, and determines a first reference vector located at the shortest distance from a learning vector, among reference vectors belonging to the same class as the learning vector. In addition, the reference vector selection unit 113 determines a second reference vector located at the shortest distance from the learning vector, among reference vectors belonging to a class different from the class to which the learning vector belongs. Then, the reference vector selection unit 113 selects, as reference vectors to be corrected, the determined first reference vector and second reference vector.

In the case where there is a plurality of classes different from the class to which the learning vector belongs, the reference vector selection unit 113 just selects at least one second reference vector. For example, the reference vector selection unit 113 may select, as the second reference vector, a reference vector closest to the learning vector among reference vectors belonging to a class different from the class to which the learning vector belongs. Alternatively, the reference vector selection unit 113 may select one reference vector from each class different from the class to which the learning vector belongs.

===Correction Unit 115===

The correction unit 115 performs correction processing on the first reference vector and the second reference vector selected by the reference vector selection unit 113. The correction processing is processing for correcting a vector. Specifically, the correction in the present example embodiment refers to the rewriting of the value of a component of a reference vector stored in the reference vector storage unit 210. However, there may be a case where the value of a vector component does not change as a result of the correction processing.

The correction unit 115 corrects a reference vector belonging to the same class as the learning vector in such a way as to bring the reference vector closer to the learning vector, and corrects a reference vector belonging to a class different from the class to which the learning vector belongs in such a way as to move the reference vector away from the learning vector.

Let yₚ⁺ and y_{q}⁻ be the first reference vector and the second reference vector selected with respect to the learning vector xᵢ⁺ of the positive class, respectively. Let yᵣ⁻ and yₛ⁺ be the first reference vector and the second reference vector selected with respect to the learning vector xⱼ⁻ of the negative class, respectively. The correction unit 115 corrects the reference vectors according to, for example, the following expressions.

yₚ⁺←yₚ⁺+ε∥xᵢ⁺−y_{q}⁻∥^{m}(xᵢ⁺−yₚ⁺)

y_{q}⁻←y_{q}⁻−ε∥xᵢ⁺−yₚ⁺∥^{m}(xᵢ⁺−y_{q}⁻)

yᵣ⁻←yᵣ⁻+ε∥xⱼ⁻−yₛ⁺∥^{m}(xⱼ⁻−yᵣ⁻)

yₛ⁺←yₛ⁺−ε∥xⱼ⁻−yᵣ⁻∥^{m}(xⱼ⁻−yₛ⁺) [Math. 2]

Here, ε and m denote set values. The symbol ε denotes a positive real number, and m denotes a real number greater than 1. As a result of correction based on the above expressions, the reference vector yₚ⁺ is brought closer to xᵢ⁺, the reference vector y_{q}⁻ is moved away from xᵢ⁺, the reference vector yᵣ⁻ is brought closer to xⱼ⁻, and the reference vector yₛ⁺ is moved away from xⱼ⁻.

<Operation>

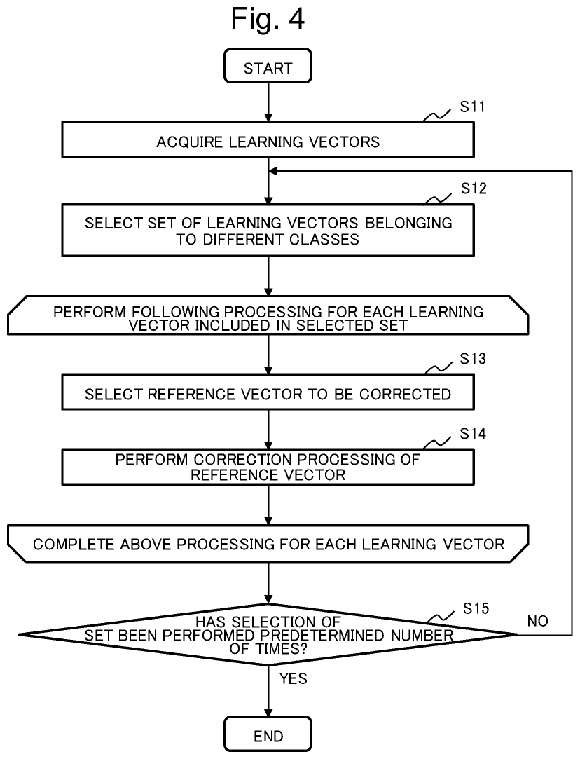

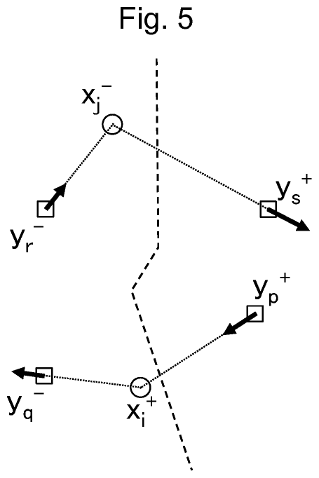

The flow of processing by the classifier correction device 11 will be described below with reference to a flowchart of FIG. 4. In the case where each processing is performed by a processor executing a program, each processing is just performed in accordance with the order of instructions in the program. In the case where each processing is performed by a separate device, a device that has completed processing just provides notification to a device to perform the next processing, so as to cause the next processing to be performed. Each unit that performs processing just receives data necessary for each processing from a unit that generated the data or read the data from the storage area of the classifier correction device 11.

First, the acquisition unit 111 acquires input data for learning, that is, learning data (step S11). The acquisition unit 111 acquires multiple pieces of learning data including at least two learning vectors belonging to different classes.

Next, the set selection unit 112 selects a set of learning vectors belonging to different classes (step S12).

The classifier correction device 11 performs the processing of steps S13 and S14 for each learning vector included in the set selected by the processing of step S12.

In step S13, the reference vector selection unit 113 selects a reference vector to be corrected.

In step S14, the correction unit 115 performs correction processing on the reference vector selected in step S13.

When the processing of steps S13 and S14 above is completed for each of the learning vectors included in the selected set, the process proceeds to step S15. For example, if a set of the first learning vector and the second learning vector is selected by the processing of step S12, the correction unit 115 performs correction processing on a total of four or more reference vectors.

In step S15, the classifier correction device 11 determines whether the set selection unit 112 has performed selection of a set a predetermined number of times. If the result of the determination is NO, the process returns to step S12, so that the classifier correction device 11 selects a new set, selects an object to be corrected, and performs correction processing. If the result of the determination in step S15 is YES, the process exits the loop, and the classifier correction device 11 terminates the process. At this time, the classifier correction device 11 may transmit a signal so as to notify completion of the correction processing.

Described below is an example of changes of the reference vectors, made in the processing by the classifier correction device 11 of the present example embodiment.

In step S12, the set selection unit 112 can select the learning vectors xᵢ⁺ and xⱼ⁻ as a set. In step S13, the reference vector selection unit 113 can select the reference vectors yₚ⁺ and y_{q}⁻ based on the learning vector xᵢ⁺, and select the reference vectors yᵣ⁻ and yₛ⁺ based on the learning vector xⱼ⁻.

The processing of step S14 can cause the reference vectors yₚ⁺, y_{q}⁻, yᵣ⁻, and yₛ⁺ to move in respective directions indicated by arrows in FIG. 5. A broken line illustrated in FIG. 5 represents a classification boundary (that is, the boundary between regions where learning vectors are classified into the same class). When the NNC is used as the classifier 21, the classification boundary is a Voronoi boundary.

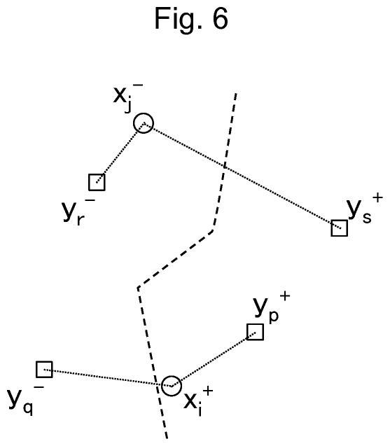

As a result of the reference vectors being moved by the correction, the reference vectors and the classification boundary may be as illustrated in FIG. 6.

### Effect

According to the classifier correction device 11, since a set of learning vectors belonging to different classes is selected and a reference vector close to each learning vector is corrected, a learning vector classified into a class with a small number of pieces of data is used for correction more effectively than in the known technique.

As a result, classification accuracy for a class with a small number of pieces of data is improved.

Therefore, the classifier correction device 11 can efficiently improve the accuracy even for, in particular, a classifier that uses data for learning in the case where there is an imbalance in the number of pieces of data between classes.

### Modified Example

A reference vector selection unit 113 may determine a classification boundary closest to a learning vector, among classification boundaries between a class to which the learning vector belongs and other classes, and select a first reference vector and a second reference vector from the two regions separated by the determined classification boundary. The first reference vector is a reference vector included in the class to which the learning vector belongs, of the two regions separated by the to determined classification boundary. The second reference vector is a reference vector included in a class to which the learning vector does not belong, of the two regions separated by the determined classification boundary.

### Second Example Embodiment

A second example embodiment of the present invention will be described.

<Configuration>

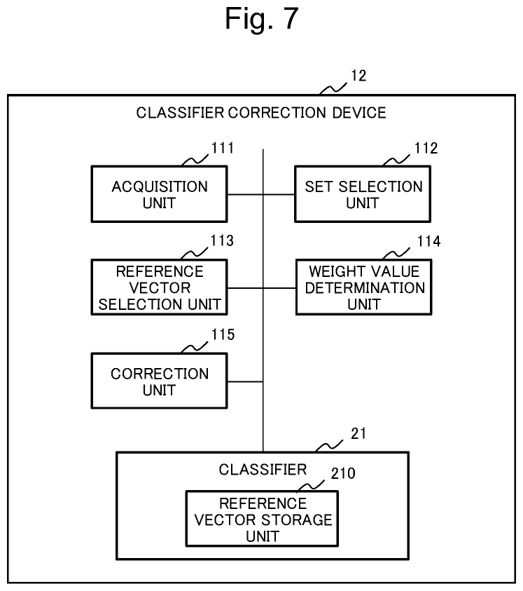

FIG. 7 is a block diagram illustrating a configuration of a classifier correction device 12 according to the second example embodiment. The classifier correction device 12 includes a weight value determination unit 114 in addition to the same units as the units included in the classifier correction device 11 of the first example embodiment. As with the other units, the weight value determination unit 114 is implemented by, for example, one or more processors that execute a program.

A difference from the classifier correction device 11 of the first example embodiment will be described in the following. Description of features common to the classifier correction devices 11 and 12 will be omitted as appropriate.

===Set Selection Unit 112===

In the present example embodiment, a set selection unit 112 selects, as a set, a pair of two learning vectors belonging to different classes. Hereinafter, the set selected by the set selection unit 112 is also referred to as “pair”.

If there are two types of classes, the set selection unit 112 selects one learning vector from each class, and selects the learning vectors as a pair.

If there are three or more types of classes, the set selection unit 112 just selects two classes out of a plurality of classes and select a pair of learning vectors from the two classes.

Two classes may be selected from among the plurality of classes by use of, for example, a method of random selection. The “method of random selection” refers to a method in which the selection of a learning vector is a stochastic event and each learning vector is selected with a uniform probability. The set selection unit 112 may select two classes by using a method other than the method of random selection.

===Weight Value Determination Unit 114===

The weight value determination unit 114 determines a weight value, which is a value serving as an index of the degree of correction of a reference vector, for the pair selected by the set selection unit 112.

The weight value can be set such that the weight value is a real number in the range of, for example, 0 to 1. For example, the weight value may be set such that the weight value is either 0 or 1.

The weight value determination unit 114 may determine the weight value based on a determination value (to be described below) by a discriminant function for each of the learning vectors forming the pair. Specifically, for example, the weight value determination unit 114 may determine a weight value such that the smaller the difference between determination values for the learning vectors forming the pair is, the larger a weight value is.

The determination value for a vector x is, for example, a value g(x) defined by the following discriminant function.

$$[ Math 3 ]$$

$$g ( x ) = \frac{{d}^{-} ( x ) - {d}^{+} ( x )}{{d}^{-} ( x ) + {d}^{+} ( x )}$$

Here, d⁺ (x) is the square of a distance to a reference vector y⁺ closest to the vector x, among reference vectors in a positive class, and d⁻ (x) is the square of a distance to a reference vector y⁻ closest to the vector x, among reference vectors in a negative class. That is, d⁺ (x) and d⁻ (x) are defined by the following equations.

d⁺(x)=∥x−y⁺∥²=(x−y⁺)·(x−y⁺)

d⁻(x)=∥x−y⁻∥²=(x−y⁻)·(x−y⁻) [Math. 4]

Here, the symbol “·” is an operator for an inner product. Reference vectors selected by a reference vector selection unit 113 may be used as the vectors y⁺ and y⁻ in the above equations.

According to the above formula for calculating g(x), as the vector x becomes closer to a reference vector of the positive class, the value of g(x) becomes closer to 1, and as the vector x becomes closer to a reference vector of the negative class, the value of g(x) becomes closer to −1. When the vector x is equidistant from the two reference vectors, that is, located on a classification boundary, g(x)=0.

The formula for calculating g(x) and the definitions of d⁺ (x) and d⁻ (x) may be changed within an idea of the present invention. For example, in some example embodiments, d⁺ (x) may be defined as the Euclidean distance between the vector x and the reference vector y⁺, and d⁻ (x) may be defined as the Euclidean distance between the vector x and the reference vector y⁻.

The weight value determination unit 114 can calculate determination values g(xᵢ⁺) and g(xⱼ⁻) respectively for learning vectors xᵢ⁺ and xⱼ⁻ forming the pair by using the above discriminant function.

Then, the weight value determination unit 114 can calculate a weight value w(xᵢ⁺, xⱼ⁻) for the pair by using, for example, the following equation.

w(xᵢ⁺,xⱼ⁻)=ƒ(g(xⱼ⁻)−g(xᵢ⁺)) [Math. 5]

Here, a function f(u) is a function defined by, for example, the following equation.

$$[ Math . 6 ]$$

$$f ( u ) = \{ \begin{matrix}1 & for \vert u \vert < b \\ 0 & otherwise\end{matrix} \qquad ( Equation 1 )$$

Here, |u| represents the absolute value of u. In the above equation, any positive real number may be set as the value of b. As an example, the value of b may be half a maximum value that |u| can take.

According to the above equation, the weight value is “1” when the absolute value of a difference between the value of the discriminant function for the data xᵢ⁺ of the positive class and the value of the discriminant function for the data xⱼ⁻ of the negative class is less than b.

Examples other than the example of the weight value calculation method described above will be described in the section [Supplement].

===Correction Unit 115===

A correction unit 115 performs correction processing on a first reference vector and a second reference vector selected by the reference vector selection unit 113. The degree of correction to be performed by the correction unit 115 in the present example embodiment can vary according to a weight value determined by the weight value determination unit 114.

Specifically, the correction unit 115 corrects a reference vector based on a calculation in which a distance traveled by the reference vector depends on the weight value w(xᵢ⁺, xⱼ⁻).

As an example, the correction unit 115 corrects reference vectors according to the following expressions.

yₚ⁺←yₚ⁺+εw(xᵢ⁺,xⱼ⁻)∥(xᵢ⁺−y_{q}⁻∥^{m}(xᵢ⁺−yₚ⁺)

y_{q}⁻←y_{q}⁻−εw(xᵢ⁺,xⱼ⁻)∥xᵢ⁺−yₚ⁺∥^{m}(xᵢ⁺−y_{q}⁻)

yᵣ⁻←yᵣ⁻+εw(xᵢ⁺,xⱼ⁻)∥xⱼ⁻−yₛ⁺∥^{m}(xⱼ⁻−yᵣ⁻)

yₛ⁺←yₛ⁺−εw(xᵢ⁺,xⱼ⁻)∥xⱼ⁻−yᵣ⁻∥^{m}(xⱼ⁻−yₛ⁺) [Math. 7]

Here, ε and m denote set values. The symbol ε denotes a positive real number, and m denotes a real number greater than 1.

The correction processing based on the above expressions causes each reference vector to move a distance based on the weight value set for the pair of xᵢ⁺ and xᵢ⁻. That is, in this correction processing, the degree of change of a reference vector to be corrected is determined according to the weight value for the pair.

According to the above expressions, the reference vectors do not change when the weight value is “0”. In other words, a vector to be corrected is corrected only when the weight value is not “0”.

<Operation>

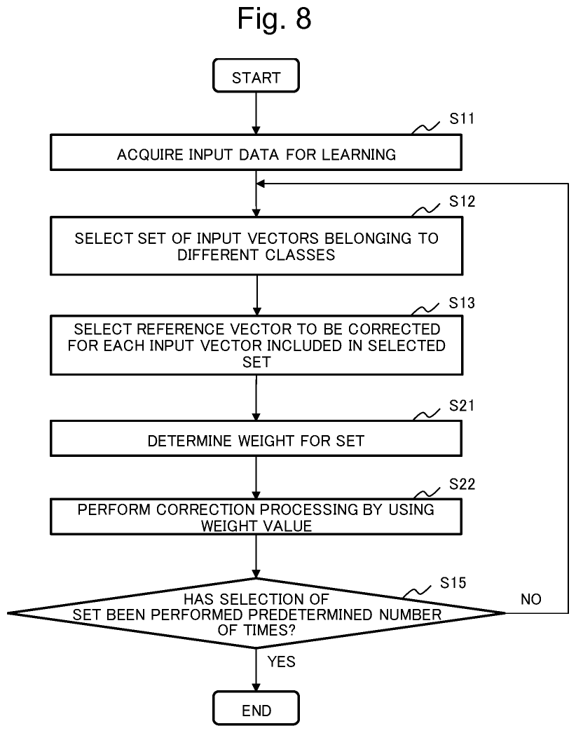

The flow of processing by the classifier correction device 12 will be described with reference to a flowchart of FIG. 8.

First, as in the flow of processing by the classifier correction device 11, the classifier correction device 12 performs the processing from step S11 to step S13. That is, an acquisition unit 111 acquires learning data, the set selection unit 112 selects a set (pair), and the reference vector selection unit 113 selects a reference vector to be corrected for each learning vector forming the set (pair).

Next, the weight value determination unit 114 determines a weight for the set (pair) (step S21). After the weight value is determined, the weight value determination unit 114 associates the pair with, for example, information representing the determined weight value. Specifically, for example, the weight value determination unit 114 may generate data in which information for specifying the pair and information representing the weight value are associated with each other. Then, the weight value determination unit 114 may record the generated data in a storage area in the classifier correction device 11 or directly transmit the data to the correction unit 115.

Then, the correction unit 115 performs correction processing on the reference vectors selected in step S13, by using the weight value (step S22).

Thereafter, in step S15, the classifier correction device 12 determines whether the set selection unit 112 has performed selection of a set (pair) a predetermined number of times. If the result of the determination is NO, the process returns to step S12, and the classifier correction device 12 selects a new pair. If the result of the determination in step S15 is YES, the process exits the loop, and the classifier correction device 12 terminates the process. At this time, the classifier correction device 12 may transmit a signal so as to notify completion of the correction processing.

[Supplement: Weight Value Determination Method]

Cited below are other examples of the method in which the weight value determination unit 114 determines a weight value.

### Example 1

For example, the function f(u) of Equation 1 above may be replaced with the following function.

$$[ Math . 8 ]$$

$$f ( u ) = \{ \begin{matrix}1 & for u > b \\ 0 & otherwise\end{matrix}$$

Here, b is any real number. According to this function, a reference vector is corrected when the value of g(xⱼ⁻) is greater than g(xᵢ⁺)+b. When b=0, a reference vector is corrected only if the learning vector xⱼ⁻ of the negative class is closer to the reference vector of the positive class than the learning vector xᵢ⁺ of the positive class.

### Example 2

The weight value determination unit 114 may determine that the weight value be “1” when a difference between distances from the classification boundary to reference vectors to be corrected is within a predetermined distance, and otherwise, may determine that the weight value be “0”.

### Example 3

The weight value determination unit 114 may determine that the weight value be a value other than “0” when one of the learning vectors included in the pair is farther from the region of a class assigned to the one of the learning vectors than the other learning vector of the same pair, and otherwise, may determine that the weight value be “0”.

The proximity/distance to the region of a class may be defined based on, for example, a distance to the nearest classification boundary, a distance to the nearest reference vector belonging to the class, or a distance from the centroid of the region of the class.

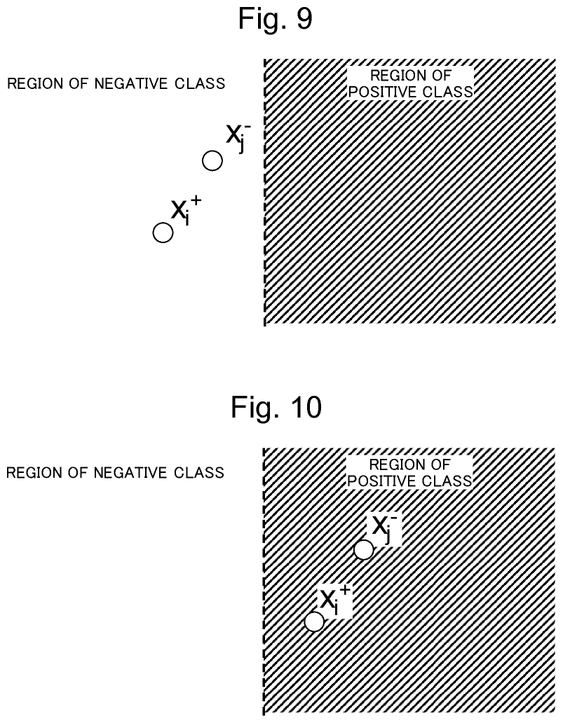

FIG. 9 is a diagram illustrating an example in which it can be said that the learning vector xᵢ⁺ of the positive class is farther from the region of the positive class than the learning vector xⱼ⁻ of the negative class. In FIG. 9, the region of the positive class is represented as a shaded area, and a broken line represents the classification boundary between the positive class and the negative class. Since both the learning vectors xᵢ⁺ and xⱼ⁻ are outside the region of the positive class, it can be said that either of the learning vectors located at a shorter distance to the classification boundary is closer to the region of the positive class. That is, in the example of FIG. 9, the learning vector xⱼ⁻ of the negative class is closer to the region of the positive class than the learning vector xᵢ⁺ because the distance from the learning vector xⱼ⁻ to the classification boundary is shorter.

Even when the learning vector xᵢ⁺ is within the region of the positive class, distance with respect to the positive class may be defined. For example, a value obtained as a result of adding a minus to a distance to the classification boundary may be used as a distance with respect to the region of the positive class. In the example illustrated in FIG. 10, it can be said that although both the learning vector xᵢ⁺ and the learning vector xⱼ⁻ are within the region of the positive class, the learning vector xⱼ⁻ is closer to the region of the positive class. It can also be said that, in this example, the learning vector xᵢ⁺ is closer to the region of the negative class than the learning vector xⱼ⁻.

The proximity/distance to the region of a class may be defined based on a distance from each of the learning vectors to the nearest reference vector belonging to the class. That is, a learning vector located at a shorter distance to the positive reference vector may be regarded as closer to the region of the positive class.

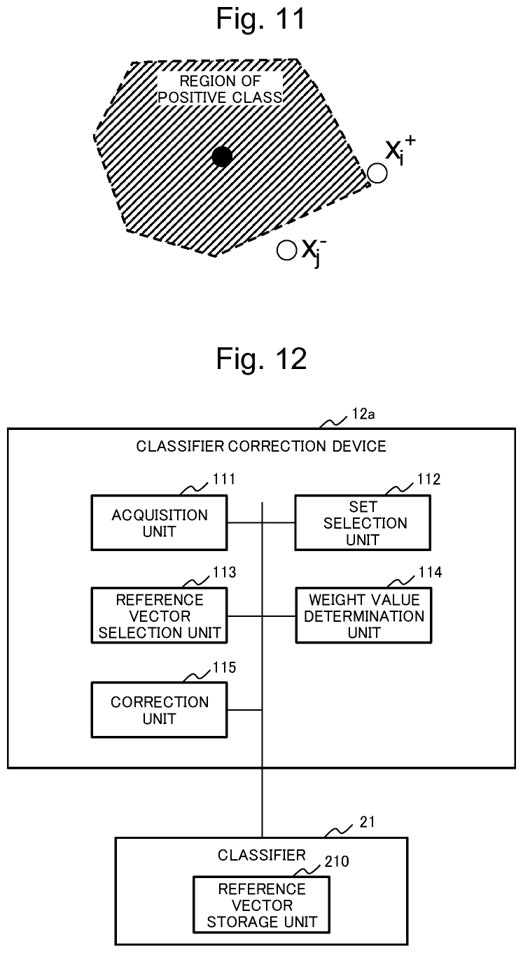

The proximity to the region of a class may be defined based on a distance to the centroid of the region of the class. FIG. 11 is a diagram illustrating an example in which it can be said that the learning vector xᵢ⁺ of the positive class is farther from the region of the positive class than the learning vector xⱼ⁻ of the negative class. In FIG. 11, the region of the positive class is represented as a shaded area, and a small black circle represents the centroid of the region of the positive class. In the example of FIG. 11, the learning vector xⱼ⁻ is closer to the centroid than the learning vector xᵢ⁺. When a learning vector located at a shorter distance to the centroid of the region of a class is defined as a learning vector closer to the class, it can be said that the learning vector xⱼ⁻ is closer to the region of the positive class than the learning vector xᵢ⁺.

### Example 4

The weight value is not limited to a value defined as a binary value of “0” or “1”. For example, the weight value determination unit 114 may determine a weight value by using a function that monotonically decreases in accordance with the absolute value of a difference between a determination value for the data xᵢ⁺ of the positive class and a determination value for the data xⱼ⁻ of the negative class.

As an example, the function f(u) of Equation 1 above may be replaced with the following function.

$$[ Math . 9 ]$$

$$f ( u ) = exp ( - \frac{{u}^{2}}{2 {σ}^{2}} )$$

Here, σ is any real number. That is, the smaller the difference between the determination value for the data xᵢ⁺ of the positive class and the determination value for the data xⱼ⁻ of the negative class is, the larger the weight value is.

<Effect>

The classifier correction device 12 according to the second example embodiment can also efficiently improve accuracy even for, in particular, a classifier that uses data for learning in the case where there is an imbalance in the number of pieces of data between classes.

Furthermore, according to the classifier correction device 12, since the degree of correction depends on the weight value, it is possible to prevent a reference vector having less need for correction from being excessively corrected. This is because, as a result of the weight value being set by use of the method described above, a reference vector close to an erroneously classified learning vector or a reference vector close to a learning vector near a classification boundary is more likely to be largely corrected. That is, a correction is likely to be made intensively in a part of a space formed in a classifier 21, in which misclassification is more likely to occur.

In particular, for a pair with a weight value of “0”, reference vectors close to learning vectors forming the pair are not corrected, so that a calculation amount regarding the correction processing of the pair is reduced. Therefore, there is also an advantage of efficiently performing correction of reference vectors and efficiently improving the classifier 21.

### Third Example Embodiment

A modified example of the second example embodiment will be described as a third example embodiment.

FIG. 12 is a block diagram illustrating a configuration of a classifier correction device 12a according to the third example embodiment. The classifier correction device 12a includes no classifier 21, and is communicably connected to an external classifier 21. As with the classifier correction device 12, the classifier correction device 12a includes an acquisition unit 111, a set selection unit 112, a reference vector selection unit 113, a weight value determination unit 114, and a correction unit 115.

The function of each unit included in the classifier correction device 12a is the same as the function of the unit with the same name included in the classifier correction device 12. The operation of the classifier correction device 12a may be the same as the operation of the classifier correction device 12 illustrated in FIG. 8.

Such a configuration also allows the classifier correction device 12a to efficiently correct reference vectors to be used by the classifier 21.

### Fourth Example Embodiment

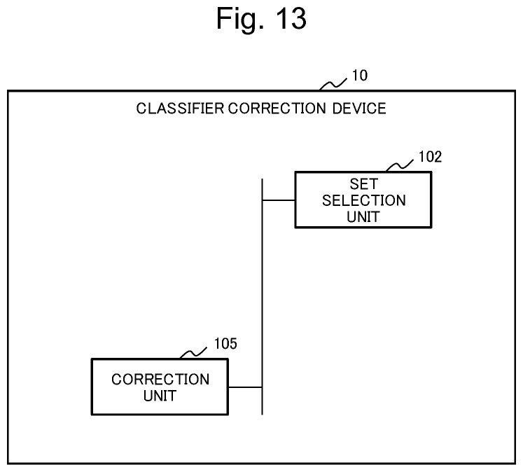

A classifier correction device 10 according to an example embodiment of the present invention will be described. FIG. 13 is a block diagram illustrating a configuration of the classifier correction device 10. The classifier correction device 10 includes a set selection unit 102 and a correction unit 105.

The classifier correction device 10 is a device that makes corrections for a classifier. As a premise, the classifier classifies a target vector into one of a plurality of classes based on a plurality of reference vectors. Each of the plurality of reference vectors belongs to any one of the plurality of classes.

Specifically, the classifier correction device 10 corrects reference vectors. Correcting reference vectors is equivalent to making corrections for the classifier.

The set selection unit 102 selects a set of learning vectors belonging to different classes from among a plurality of learning vectors. The learning vector refers to a vector serving as a basis for correction of reference vectors to be used in the classifier. Each of the plurality of learning vectors described above belongs to any one of the plurality of classes described above. In addition, at least one learning vector belongs to each of the plurality of classes described above.

The set selection unit 112 of each of the above example embodiments corresponds to an example of the set selection unit 102.

For each of the learning vectors included in the set selected by the set selection unit 102, the correction unit 105 corrects a reference vector specified based on the learning vector by using the learning vector as a basis.

The correction unit 115 of each of the above example embodiments corresponds to an example of the correction unit 105.

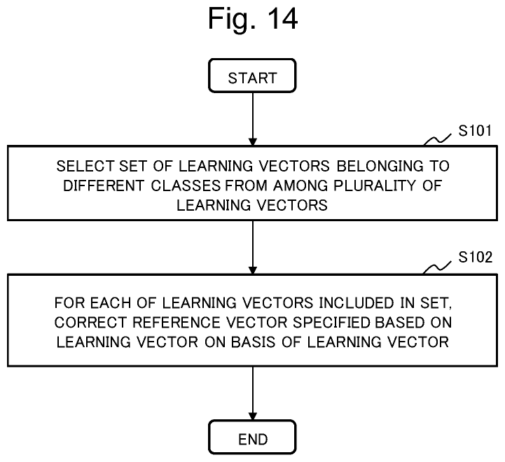

The flow of processing by the classifier correction device 10 will be described with reference to a flowchart of FIG. 14.

First, the set selection unit 102 selects a set of learning vectors belonging to different classes from among a plurality of learning vectors (step S101).

Next, for each of the learning vectors included in the set selected by the set selection unit 102, the correction unit 105 corrects a reference vector specified based on the learning vector by using the learning vector as a basis (step S102).

According to the classifier correction device 10, accuracy can be efficiently improved even for, in particular, a classifier that performs classification in the case where there is an imbalance in the number of pieces of data between classes. This is because, since the set selection unit 102 selects a set of learning vectors belonging to different classes and the correction unit 105 corrects a reference vector specified on the basis of each of the learning vectors, a learning vector classified into a class with a small number of pieces of data is used for correction more effectively than in the known technique.

<Hardware Configuration for Implementing Each Unit of Example Embodiment>

In each of the example embodiments of the present invention described above, respective blocks representing constituent elements of each device are illustrated in functional units. However, the blocks representing the constituent elements do not necessarily imply that the constituent elements are configured as separate modules.

The processing by each constituent element may be implemented by, for example, a computer system reading and executing a program that is stored on a computer-readable storage medium and causes the computer system to perform the processing. Examples of the “computer-readable storage medium” include portable media such as an optical disk, a magnetic disk, a magneto-optical disk, and a nonvolatile semiconductor memory, and storage devices such as a ROM and a hard disk incorporated in a computer system. Examples of the “computer-readable storage medium” also include a medium that can temporarily hold a program, such as a volatile memory in a computer system, and a network and a communication line such as a telephone line to be used for transmission of a program. In addition, the above program may be a program for implementing some of the above functions, and may also be a program that can implement the above functions in combination with a program previously stored in the computer system.

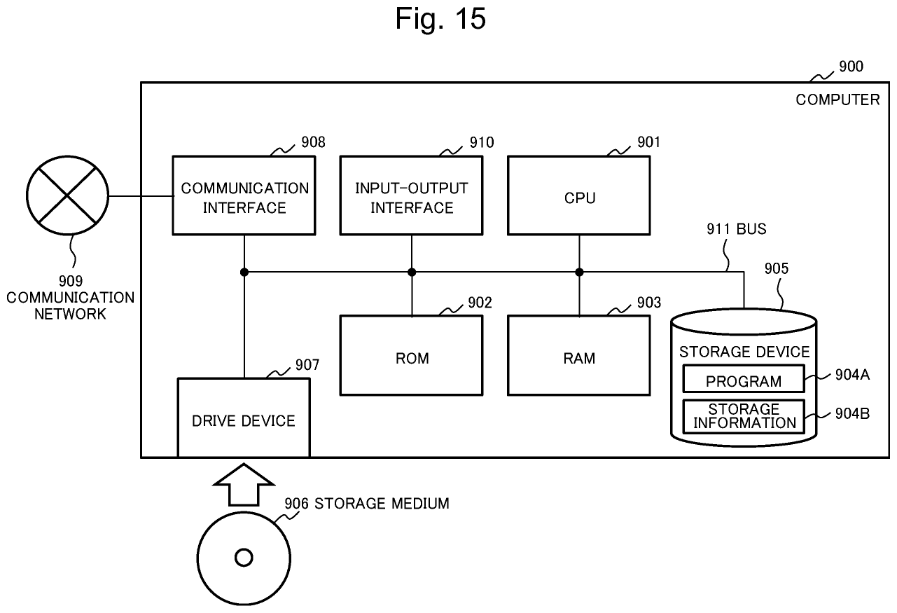

As an example, the “computer system” is a system that includes a computer 900 as illustrated in FIG. 15. The computer 900 includes the following constituent elements.
One or more central processing units (CPUs) 901
A ROM 902
A RAM 903
A program 904A to be loaded into the RAM 903 and storage information 904B
A storage device 905 that stores the program 904A and the storage information 904B
A drive device 907 that reads/writes data from/to a storage medium 906
A communication interface 908 connected to a communication network 909
An input-output interface 910 for data input/output
A bus 911 connecting the constituent elements

For example, each constituent element of each device in each example embodiment is implemented by the CPU 901 loading the program 904A that implements the function of the constituent element into the RAM 903 and executing the program 904A. The program 904A that implements the function of each constituent element of each device is stored in, for example, the storage device 905 or the ROM 902 in advance. Then, the CPU 901 reads the program 904A as needed. The storage device 905 is, for example, a hard disk. The program 904A may be supplied to the CPU 901 via the communication network 909, or may be stored in advance in the storage medium 906, read by the drive device 907, and supplied to the CPU 901. The storage medium 906 is, for example, a portable medium such as an optical disk, a magnetic disk, a magneto-optical disk, or a nonvolatile semiconductor memory.

There are various modified examples of the method for implementing each device. For example, each device may be implemented by a possible combination of the computer 900 and a program that are separately provided for each constituent element. A plurality of constituent elements included in each device may also be implemented by a possible combination of the single computer 900 and a program.

In addition, some or all of the constituent elements of each device may be implemented by other general-purpose or dedicated circuitry, a computer, or the like, or a combination thereof. These may be configured by use of a single chip or a plurality of chips connected via the bus.

In the case where some or all of the constituent elements of each device are implemented by a plurality of computers, circuits, or the like, the plurality of computers, circuits, or the like may be arranged in a centralized manner or in a decentralized manner. For example, computers, circuits, or the like may be implemented as a client and server system, a cloud computing system, or the like, in which the computers, circuits, or the like are connected via a communication network.

Some or all of the above example embodiments may also be described as set forth in the following supplementary notes, but are not limited thereto.

### SUPPLEMENTARY NOTES

### Supplementary Note 1

A classifier correction device for a classifier that classifies a target vector into one of a plurality of classes based on a plurality of reference vectors each belonging to any one of the plurality of classes, the classifier correction device including:
a set selection means for selecting a set of learning vectors belonging to different classes from among a plurality of learning vectors each belonging to any one of the plurality of classes, each of the plurality of classes having at least one of the plurality of learning vectors; and
a correction means for performing correction processing for each of the learning vectors included in the set in such a way as to correct, by using the learning vector as a basis, the reference vector specified based on the learning vector.

### Supplementary Note 2

The classifier correction device according to supplementary note 1, wherein
the set is a pair of the learning vectors,
the classifier correction device further includes a weight value determination means for determining a weight value for the pair based on a relationship between the learning vectors included in the pair, and
the correction means performs the correction processing of the reference vector specified based on the learning vector included in the pair in such a way that a degree of change of the reference vector to be corrected is determined according to the weight value for the pair.

### Supplementary Note 3

The classifier correction device according to supplementary note 2, wherein
the weight value determination means determines the weight value based on a relationship between:
a first value determined according to at least either a distance between a first learning vector included in the pair and a first reference vector closest to the first learning vector, the first reference vector being among the reference vectors belonging to a same class as the first learning vector, or a distance between the first learning vector and a second reference vector closest to the first learning vector, the second reference vector being among the reference vectors belonging to a class different from the class to which the first learning vector belongs; and
a second value determined according to at least either a distance between a second learning vector included in the pair and a third reference vector closest to the second learning vector, the third reference vector being among the reference vectors belonging to a same class as the second learning vector, or a distance between the second learning vector and a fourth reference vector closest to the second learning vector, the fourth reference vector being among the reference vectors belonging to a class different from the class to which the second learning vector belongs.

### Supplementary Note 4

The classifier correction device according to supplementary note 3, wherein
the first value is a value that decreases as an excess of the distance between the first learning vector and the first reference vector over the distance between the first learning vector and the second reference vector increases,
the second value is a value that increases as an excess of the distance between the second learning vector and the third reference vector over the distance between the second learning vector and the fourth reference vector increases,
the weight value determination means sets a specific value as the weight value for the pair when a value obtained by subtraction of the first value from the second value exceeds a predetermined value, and
the correction means does not perform the correction processing by using the learning vector included in the pair as a basis when the weight value for the pair is the specific value.

### Supplementary Note 5

The classifier correction device according to supplementary note 3, wherein
the first value is a value that decreases as an excess of the distance between the first learning vector and the first reference vector over the distance between the first learning vector and the second reference vector increases,
the second value is a value that increases as an excess of the distance between the second learning vector and the third reference vector over the distance between the second learning vector and the fourth reference vector increases,
the weight value determination means sets a specific value as the weight value for the pair when an absolute value of a difference between the first value and the second value is less than a predetermined value, and
the correction means does not perform the correction processing by using the learning vector included in the pair as a basis when the weight value for the pair is the specific value.

### Supplementary Note 6

The classifier correction device according to supplementary note 3, wherein
the first value is a value that decreases as an excess of the distance between the first learning vector and the first reference vector over the distance between the first learning vector and the second reference vector increases,
the second value is a value that increases as an excess of the distance between the second learning vector and the third reference vector over the distance between the second learning vector and the fourth reference vector increases, and
the weight value determination means determines the weight value in such a way that the weight value decreases as a value obtained by subtraction of the first value from the second value increases.

### Supplementary Note 7

The classifier correction device according to supplementary note 2, wherein
the weight value determination means sets a specific value as the weight value for the pair when a distance between a first learning vector included in the pair and a first reference vector closest to the first learning vector, the first reference vector being among the reference vectors belonging to a same class as the first learning vector is less than a distance between a second learning vector included in the pair and a second reference vector closest to the second learning vector, the second reference vector being among the reference vectors belonging to the same class as the first learning vector, and
the correction means does not perform the correction processing by using the learning vector included in the pair as a basis when the weight value for the pair is the specific value.

### Supplementary Note 8

The classifier correction device according to any one of supplementary notes 1 to 7, wherein
the set selection means selects the set by selecting the learning vectors, one from each of the plurality of classes, or by selecting a given number of classes from among the plurality of classes and then selecting the learning vectors, one from each of the selected classes, and
the classifier correction device repeatedly performs selection of the set by the set selection means and the correction processing by the correction means.

### Supplementary Note 9

A classifier correction method for a classifier that classifies a target vector into one of a plurality of classes based on a plurality of reference vectors each belonging to any one of the plurality of classes, the method including:
selecting a set of learning vectors belonging to different classes from among a plurality of learning vectors each belonging to any one of the plurality of classes, each of the plurality of classes having at least one of the plurality of learning vectors; and
performing correction processing for each of the learning vectors included in the set in such a way as to correct, by using the learning vector as a basis, the reference vector specified based on the learning vector.

### Supplementary Note 10

The classifier correction method according to supplementary note 9, wherein
the set is a pair of the learning vectors, and
the classifier correction method further includes:
determining a weight value for the pair based on a relationship between the learning vectors included in the pair; and
performing the correction processing of the reference vector specified based on the learning vector included in the pair in such a way that a degree of change of the reference vector to be corrected is determined according to the weight value for the pair.

### Supplementary Note 11

The classifier correction method according to supplementary note 10, wherein
in determining the weight value for the pair, the weight value is determined based on a relationship between:
a first value determined according to at least either a distance between a first learning vector included in the pair and a first reference vector closest to the first learning vector, the first reference vector being among the reference vectors belonging to a same class as the first learning vector, or a distance between the first learning vector and a second reference vector closest to the first learning vector, the second reference vector being among the reference vectors belonging to a class different from the class to which the first learning vector belongs; and
a second value determined according to at least either a distance between a second learning vector included in the pair and a third reference vector closest to the second learning vector, the third reference vector being among the reference vectors belonging to a same class as the to second learning vector, or a distance between the second learning vector and a fourth reference vector closest to the second learning vector, the fourth reference vector being among the reference vectors belonging to a class different from the class to which the second learning vector belongs.

### Supplementary Note 12

The classifier correction method according to supplementary note 11, wherein
the first value is a value that decreases as an excess of the distance between the first learning vector and the first reference vector over the distance between the first learning vector and the second reference vector increases,
the second value is a value that increases as an excess of the distance between the second learning vector and the third reference vector over the distance between the second learning vector and the fourth reference vector increases,
a specific value is set as the weight value for the pair when a value obtained by subtraction of the first value from the second value exceeds a predetermined value, and
the correction processing by use of the learning vector included in the pair as a basis is not performed when the weight value for the pair is the specific value.

### Supplementary Note 13

The classifier correction method according to supplementary note 11, wherein
the first value is a value that decreases as an excess of the distance between the first learning vector and the first reference vector over the distance between the first learning vector and the second reference vector increases,
the second value is a value that increases as an excess of the distance between the second learning vector and the third reference vector over the distance between the second learning vector and the fourth reference vector increases,
a specific value is set as the weight value for the pair when an absolute value of a difference between the first value and the second value is less than a predetermined value, and
the correction processing by use of the learning vector included in the pair as a basis is not performed when the weight value for the pair is the specific value.

### Supplementary Note 14

The classifier correction method according to supplementary note 11, wherein
the first value is a value that decreases as an excess of the distance between the first learning vector and the first reference vector over the distance between the first learning vector and the second reference vector increases,
the second value is a value that increases as an excess of the distance between the second learning vector and the third reference vector over the distance between the second learning vector and the fourth reference vector increases, and
the weight value is determined in such a way that the weight value decreases as a value obtained by subtraction of the first value from the second value increases.

### Supplementary Note 15

The classifier correction method according to supplementary note 10, wherein
a specific value is set as the weight value for the pair when a distance between a first learning vector included in the pair and a first reference vector closest to the first learning vector, the first reference vector being among the reference vectors belonging to a same class as the first learning vector is less than a distance between a second learning vector included in the pair and a second reference vector closest to the second learning vector, the second reference vector being among the reference vectors belonging to the same class as the first learning vector, and
the correction processing by use of the learning vector included in the pair as a basis is not performed when the weight value for the pair is the specific value.

### Supplementary Note 16

The classifier correction method according to any one of supplementary notes 9 to 15, wherein
in selecting the set, the set is selected by selection of the learning vectors, one from each of the plurality of classes, or by selection of a given number of classes from among the plurality of classes and subsequent selection of the learning vectors, one from each of the selected classes, and
the classifier correction method further includes repeatedly performing selection of the set and the correction processing.

### Supplementary Note 17

A computer-readable storage medium storing a program for a classifier that classifies a target vector into one of a plurality of classes based on a plurality of reference vectors each belonging to any one of the plurality of classes, the program causing a computer to perform:
set selection processing of selecting a set of learning vectors belonging to different classes from among a plurality of learning vectors each belonging to any one of the plurality of classes, each of the plurality of classes having at least one of the plurality of learning vectors; and
correction processing for each of the learning vectors included in the set in such a way as to correct, by using the learning vector as a basis, the reference vector specified based on the learning vector.

### Supplementary Note 18

The storage medium according to supplementary note 17, wherein
the set is a pair of the learning vectors,
the program causes the computer to further perform weight value determination processing of determining a weight value for the pair based on a relationship between the learning vectors included in the pair, and
in the correction processing, correction of the reference vector specified based on the learning vector included in the pair is performed in such a way that a degree of change of the reference vector to be corrected is determined according to the weight value for the pair.

### Supplementary Note 19

The storage medium according to supplementary note 18, wherein
in the weight value determination processing, the weight value is determined based on a relationship between:
a first value determined according to at least either a distance between a first learning vector included in the pair and a first reference vector closest to the first learning vector, the first reference vector being among the reference vectors belonging to a same class as the first learning vector, or a distance between the first learning vector and a second reference vector closest to the first learning vector, the second reference vector being among the reference vectors belonging to a class different from the class to which the first learning vector belongs; and
a second value determined according to at least either a distance between a second learning vector included in the pair and a third reference vector closest to the second learning vector, the third reference vector being among the reference vectors belonging to a same class as the second learning vector, or a distance between the second learning vector and a fourth reference vector closest to the second learning vector, the fourth reference vector being among the reference vectors belonging to a class different from the class to which the second learning vector belongs.

### Supplementary Note 20

The storage medium according to supplementary note 19, wherein
the first value is a value that decreases as an excess of the distance between the first learning vector and the first reference vector over the distance between the first learning vector and the second reference vector increases,
the second value is a value that increases as an excess of the distance between the second learning vector and the third reference vector over the distance between the second learning vector and the fourth reference vector increases,
in the weight value determination processing, a specific value is set as the weight value for the pair when a value obtained by subtraction of the first value from the second value exceeds a predetermined value, and
in the correction processing, correction in such a way that the reference vector specified based on the learning vector included in the pair is corrected by use of the learning vector as a basis is not performed when the weight value for the pair is the specific value.

### Supplementary Note 21

The storage medium according to supplementary note 19, wherein
the first value is a value that decreases as an excess of the distance between the first learning vector and the first reference vector over the distance between the first learning vector and the second reference vector increases,
the second value is a value that increases as an excess of the distance between the second learning vector and the third reference vector over the distance between the second learning vector and the fourth reference vector increases,
in the weight value determination processing, a specific value is set as the weight value for the pair when an absolute value of a difference between the first value and the second value is less than a predetermined value, and
in the correction processing, correction in such a way that the reference vector specified based on the learning vector included in the pair is corrected by use of the learning vector as a basis is not performed when the weight value for the pair is the specific value.

### Supplementary Note 22

The storage medium according to supplementary note 19, wherein
the first value is a value that decreases as an excess of the distance between the first learning vector and the first reference vector over the distance between the first learning vector and the second reference vector increases,
the second value is a value that increases as an excess of the distance between the second learning vector and the third reference vector over the distance between the second learning vector and the fourth reference vector increases, and
in the weight value determination processing, the weight value is determined in such a way that the weight value decreases as a value obtained by subtraction of the first value from the second value increases.

### Supplementary Note 23

The storage medium according to supplementary note 18, wherein
in the weight value determination processing, a specific value is set as the weight value for the pair when a distance between a first learning vector included in the pair and a first reference vector closest to the first learning vector, the first reference vector being among the reference vectors belonging to a same class as the first learning vector is less than a distance between a second learning vector included in the pair and a second reference vector closest to the second learning vector, the second reference vector being among the reference vectors belonging to the same class as the first learning vector, and
in the correction processing, correction in such a way that the reference vector specified based on the learning vector included in the pair is corrected by use of the learning vector as a basis is not performed when the weight value for the pair is the specific value.

### Supplementary Note 24

The storage medium according to any one of supplementary notes 17 to 23, wherein
in the set selection processing, the set is selected by selection of the learning vectors, one from each of the plurality of classes, or by selection of a given number of classes from among the plurality of classes and subsequent selection of the learning vectors, one from each of the selected classes, and
the program causes the computer to repeatedly perform the set selection processing and the correction processing.

The present invention is not limited to the example embodiments described above. Various modifications that can be understood by those skilled in the art can be made to the configurations and details of the example embodiments described above within the scope of the present invention.

The present application claims priority based on Japanese Patent Application No. 2018-051209 filed on Mar. 19, 2018, the disclosure of which is incorporated herein by reference in its entirety.

### REFERENCE SIGNS LIST

10, 11, 12, 12a classifier correction device
111 acquisition unit
102, 112 set selection unit
113 reference vector selection unit
114 weight value determination unit
105, 115 correction unit
21 classifier
210 reference vector storage unit
900 computer
901 CPU
902 ROM
903 RAM
904A program
904B storage information
905 storage device
906 storage medium
907 drive device
908 communication interface
909 communication network
910 input-output interface
911 bus

What is claimed is:

1. A classifier correction device for a classifier that classifies a target vector into one of a plurality of classes based on a plurality of reference vectors each belonging to any one of the plurality of classes, the classifier correction device comprising:
a memory storing instructions; and
one or more processors configured to execute the instructions to:
select a set of learning vectors belonging to different classes from among a plurality of learning vectors each belonging to any one of the plurality of classes, each of the plurality of classes having at least one of the plurality of learning vectors; and
perform correction processing for each of the learning vectors included in the set in such a way as to correct, by using the learning vector as a basis, the reference vector specified based on the learning vector.

2. The classifier correction device according to claim 1, wherein
the set is a pair of the learning vectors, and
the one or more processors are configured to execute the instructions to:
determine a weight value for the pair based on a relationship between the learning vectors included in the pair, and
perform the correction processing of the reference vector specified based on the learning vector included in the pair in such a way that a degree of change of the reference vector to be corrected is determined according to the weight value for the pair.

3. The classifier correction device according to claim 2, wherein
the one or more processors are configured to execute the instructions to:
determine the weight value based on a relationship between:
a first value determined according to at least either a distance between a first learning vector included in the pair and a first reference vector closest to the first learning vector, the first reference vector being among the reference vectors belonging to a same class as the first learning vector, or a distance between the first learning vector and a second reference vector closest to the first learning vector, the second reference vector being among the reference vectors belonging to a class different from the class to which the first learning vector belongs; and
a second value determined according to at least either a distance between a second learning vector included in the pair and a third reference vector closest to the second learning vector, the third reference vector being among the reference vectors belonging to a same class as the second learning vector, or a distance between the second learning vector and a fourth reference vector closest to the second learning vector, the fourth reference vector being among the reference vectors belonging to a class different from the class to which the second learning vector belongs.

4. The classifier correction device according to claim 3, wherein
the first value is a value that decreases as an excess of the distance between the first learning vector and the first reference vector over the distance between the first learning vector and the second reference vector increases,
the second value is a value that increases as an excess of the distance between the second learning vector and the third reference vector over the distance between the second learning vector and the fourth reference vector increases, and
the one or more processors are configured to execute the instructions to:
set a specific value as the weight value for the pair when a value obtained by subtraction of the first value from the second value exceeds a predetermined value, and
not perform the correction processing by using the learning vector included in the pair as a basis when the weight value for the pair is the specific value.

5. The classifier correction device according to claim 3, wherein
the first value is a value that decreases as an excess of the distance between the first learning vector and the first reference vector over the distance between the first learning vector and the second reference vector increases,
the second value is a value that increases as an excess of the distance between the second learning vector and the third reference vector over the distance between the second learning vector and the fourth reference vector increases, and
the one or more processors are configured to execute the instructions to:
set a specific value as the weight value for the pair when an absolute value of a difference between the first value and the second value is less than a predetermined value, and
not perform the correction processing by using the learning vector included in the pair as a basis when the weight value for the pair is the specific value.

6. The classifier correction device according to claim 3, wherein
the first value is a value that decreases as an excess of the distance between the first learning vector and the first reference vector over the distance between the first learning vector and the second reference vector increases,
the second value is a value that increases as an excess of the distance between the second learning vector and the third reference vector over the distance between the second learning vector and the fourth reference vector increases, and
the one or more processors are configured to execute the instructions to:
determine the weight value in such a way that the weight value decreases as a value obtained by subtraction of the first value from the second value increases.

7. The classifier correction device according to claim 2, wherein
the one or more processors are configured to execute the instructions to:
set a specific value as the weight value for the pair when a distance between a first learning vector included in the pair and a first reference vector closest to the first learning vector, the first reference vector being among the reference vectors belonging to a same class as the first learning vector is less than a distance between a second learning vector included in the pair and a second reference vector closest to the second learning vector, the second reference vector being among the reference vectors belonging to the same class as the first learning vector, and
not perform the correction processing by using the learning vector included in the pair as a basis when the weight value for the pair is the specific value.

8. The classifier correction device according to claim 1, wherein
the one or more processors are configured to execute the instructions to:
select the set by selecting the learning vectors, one from each of the plurality of classes, or by selecting a given number of classes from among the plurality of classes and then selecting the learning vectors, one from each of the selected classes, and
repeatedly perform selection of the set and the correction processing.

9. A classifier correction method for a classifier that classifies a target vector into one of a plurality of classes based on a plurality of reference vectors each belonging to any one of the plurality of classes, the method comprising:
selecting a set of learning vectors belonging to different classes from among a plurality of learning vectors each belonging to any one of the plurality of classes, each of the plurality of classes having at least one of the plurality of learning vectors; and
performing correction processing for each of the learning vectors included in the set in such a way as to correct, by using the learning vector as a basis, the reference vector specified based on the learning vector.

10. The classifier correction method according to claim 9, wherein
the set is a pair of the learning vectors, and
the classifier correction method further comprises:
determining a weight value for the pair based on a relationship between the learning vectors included in the pair; and
performing the correction processing of the reference vector specified based on the learning vector included in the pair in such a way that a degree of change of the reference vector to be corrected is determined according to the weight value for the pair.

11. The classifier correction method according to claim 10, wherein
in determining the weight value for the pair, the weight value is determined based on a relationship between:
a first value determined according to at least either a distance between a first learning vector included in the pair and a first reference vector closest to the first learning vector, the first reference vector being among the reference vectors belonging to a same class as the first learning vector, or a distance between the first learning vector and a second reference vector closest to the first learning vector, the second reference vector being among the reference vectors belonging to a class different from the class to which the first learning vector belongs; and
a second value determined according to at least either a distance between a second learning vector included in the pair and a third reference vector closest to the second learning vector, the third reference vector being among the reference vectors belonging to a same class as the second learning vector, or a distance between the second learning vector and a fourth reference vector closest to the second learning vector, the fourth reference vector being among the reference vectors belonging to a class different from the class to which the second learning vector belongs.

12. The classifier correction method according to claim 11, wherein
the first value is a value that decreases as an excess of the distance between the first learning vector and the first reference vector over the distance between the first learning vector and the second reference vector increases,
the second value is a value that increases as an excess of the distance between the second learning vector and the third reference vector over the distance between the second learning vector and the fourth reference vector increases,
a specific value is set as the weight value for the pair when a value obtained by subtraction of the first value from the second value exceeds a predetermined value, and
the correction processing by use of the learning vector included in the pair as a basis is not performed when the weight value for the pair is the specific value.

13. The classifier correction method according to claim 11, wherein
the first value is a value that decreases as an excess of the distance between the first learning vector and the first reference vector over the distance between the first learning vector and the second reference vector increases,
the second value is a value that increases as an excess of the distance between the second learning vector and the third reference vector over the distance between the second learning vector and the fourth reference vector increases,
a specific value is set as the weight value for the pair when an absolute value of a difference between the first value and the second value is less than a predetermined value, and
the correction processing by use of the learning vector included in the pair as a basis is not performed when the weight value for the pair is the specific value.

14. The classifier correction method according to claim 11, wherein
the first value is a value that decreases as an excess of the distance between the first learning vector and the first reference vector over the distance between the first learning vector and the second reference vector increases,
the second value is a value that increases as an excess of the distance between the second learning vector and the third reference vector over the distance between the second learning vector and the fourth reference vector increases, and
the weight value is determined in such a way that the weight value decreases as a value obtained by subtraction of the first value from the second value increases.

15. The classifier correction method according to claim 10, wherein
a specific value is set as the weight value for the pair when a distance between a first learning vector included in the pair and a first reference vector closest to the first learning vector, the first reference vector being among the reference vectors belonging to a same class as the first learning vector is less than a distance between a second learning vector included in the pair and a second reference vector closest to the second learning vector, the second reference vector being among the reference vectors belonging to the same class as the first learning vector, and
the correction processing by use of the learning vector included in the pair as a basis is not performed when the weight value for the pair is the specific value.

16. The classifier correction method according to claim 9, wherein
in selecting the set, the set is selected by selection of the learning vectors, one from each of the plurality of classes, or by selection of a given number of classes from among the plurality of classes and subsequent selection of the learning vectors, one from each of the selected classes, and
the classifier correction method further comprises repeatedly performing selection of the set and the correction processing.

17. A non-transitory computer-readable storage medium storing a program for a classifier that classifies a target vector into one of a plurality of classes based on a plurality of reference vectors each belonging to any one of the plurality of classes, the program causing a computer to perform:
set selection processing of selecting a set of learning vectors belonging to different classes from among a plurality of learning vectors each belonging to any one of the plurality of classes, each of the plurality of classes having at least one of the plurality of learning vectors; and
correction processing for each of the learning vectors included in the set in such a way as to correct, by using the learning vector as a basis, the reference vector specified based on the learning vector.

18.-24. (canceled)
